(19) United States
(12) Patent Application Publication
(10) Pub. No.: US 2010/0269762 A1
(43) Pub. Date: Oct. 28, 2010

(54) Animal Deterrent Apparatus

(76) Inventor: Pride Johnson, Kalispell, MT (US)

Correspondence Address: JACKSON ESQUIRE;ROGER A. JACKSON, 209 KALAMATH STREET, UNIT 9, DENVER, CO, 80223-1348, US

(21) Appl. No.: 12/427,895

(22) Filed: Apr. 22, 2009

(51) Int. Cl. A01K 29/00; B65D 83/00

(52) U.S. Cl. 119/712; 222/394

(57) ABSTRACT

An animal deterrent apparatus and method is disclosed to help prevent an attack by an animal, the apparatus includes a base extending to a surrounding sidewall that terminates in an aperture, the base and sidewall defining an interior. The apparatus also includes a valve disposed within the aperture, the valve having a selected open state and a normally closed state. Further the apparatus includes a nozzle adjacent to the valve being in fluid communication with the valve, when the valve is in the open state fluid communication is from the interior to the environment and when the valve is closed state fluid communication is precluded from the interior to the environment. Further, a composition is disposed within the interior that includes a capsicum element, a heavy solvent, an emulsifier, and a light propellant, operationally the composition is dispersed from the interior to the environment being directed at the animal.

### FIELD OF THE INVENTION

The present invention relates generally to a propellant used in a non-lethal deterrent spray for use against an attacking entity that poses a risk of harm or death to an individual user of the non-lethal deterrent spray. More particularly, the present invention relates to a propellant in an animal deterring spray that is less harmful to the environment when used in conjunction with an animal deterrent chemical.

### BACKGROUND OF THE INVENTION

Exploring the wilderness can be a rewarding, educational, or necessary task depending upon a single individual's needs. When exploring the outdoors, one may encounter a variety of wildlife, such as flora, fauna, and animals, some of which are safe while others are dangerous. In regards to potentially dangerous animals, such as bears, moose, wolves, mountain lions, and the like, how does someone protect themselves without creating permanent harm to the animal from being attacked, in a safe and convenient manner, or in the situation where guns are not allowed, this is where the desirable potential of an animal deterrent apparatus comes into play.

Typically an individual's first instinct when coming into contact with a dangerous animal is to take flight by running and hiding. Rather than watching the person run away, the animal can respond by chasing after the individual, as it would when encountering any of its prey, noting that most animals can typically outrun a human. Prior art choices for the individual to defend themselves from animal attack included knives and spears, however, in modern times a person has something to fight back with the introduction of firearms, all of which can cause permanent animal harm. Thus now when a person comes across an animal, rather than running or fighting, the individual may point and shoot, because gun fire outruns any animal. However, for those individual's not wishing to carry a gun or venture to areas where guns may be prohibited, a need for a more humane alternative to guns is needed to protect against an animal attack.

Self defense spray is typically categorized into human to human use type (properly termed “Self Defense Spray”) or human to animal use type (properly termed “Animal Deterrent Spray”). The human to animal type is actually classified as a pesticide. Generally, both the self defense spray apparatus and the animal deterrent spray apparatus have similar basic components, beginning with a pressure containing canister, a valve for selectably releasing the contents of the canister, a spray nozzle for controlled diffusion and atomization of the canister contents spray stream or fogging mist. With the canister contents including a propellant, a solvent, and a disabling (lachrymatory) agent-typically termed Oleoresin Capsicum (pepper element) or an equivalent, which is operational to severely irritate all of the head openings such as eyes, nose, and throat causing a temporary (typically about 30-60 minutes) disability of the human or animal it is directed at. The self defense or animal deterrent spray (generically termed “Pepper Spray”) can cause temporary blindness, excessive eye watering, acute coughing spasms coupled with difficulty in breathing and talking, wherein the aforementioned effects gradually wear off over a period of hours. These pepper spray effects are not easily removed as the Oleoresin Capsicum element is not water soluable (i.e. cannot be washed off easily), sometimes color dyes are also added to the pepper spray for the user to have visual identification of where they have had the pepper spray contact the human or animal. The Oleoresin Capsicum element must be modified to be used in a distance projecting a finely atomized spray stream or long distance fogging mist to allow the user to quickly defend themselves when they are being attacked by a human or animal, this is where the self defense spray apparatus comes into play as briefly previously described.

Capsicum is originally made from finely ground peppers and optionally additional like elements, wherein an organic solvent, such as ethanol is used to extract the capsicum from the finely ground peppers or an equivalent substance and when the solvent is evaporated, vegetable oil can be added having the result of a wax like resin being formed that is termed oleoresin capsicum. Further, an emulsifier is used such as propylene glycol or an equivalent to suspend the oleoresin capsicum in a liquid, wherein this liquid is disposed within the canister and a propellant is added to pressurize the mixture for dispersion energy out of the valve and nozzle as previously described for controlled diffusion and atomization of the pepper spray. There are many variables related to the pepper spray apparatus such as intensity or strength of the oleoresin capsicum concentration that is rated in performance liquid chromatography (HPLC) or Scoville heat units (SHU), the volumetric capacity of the canister, the distance projection of the spray bearing upon canister pressure available from the propellant, the mass weight of the solution fluid, and the design of the valve and spray nozzle for orifice spray diffusion effects. Typically the canister is volumetrically size limited to be a handheld portable unit, so that the volumetric capacity goes from a small amount (i.e. pocket size for about ½ to 1 ounce of fluid) to a volumetric size that is worn on a belt with a holster for example (that could go upwards of about 12 to 15 ounces of fluid or so), in either case for the canister to be quickly and easily grasped by the user for spraying the criminal or animal in an expeditious manner. Assuming the previously mentioned canister volumetric size limitations and that the oleoresin capsicum concentration level is a given, along with the design of the valve and nozzle, the following description will focus upon the propellant and fluid mixture disposed within the canister.

It is well recognized in the prior art that the propellant is an integral part of the pepper spray apparatus that has been used to thwart an attack by a criminal or animal as against the user of the pepper spray. Note that propellants are also widely used for many other aerosol spray applications utilizing a portable handheld canister, such as hair sprays, spray paints, equipment pressure cleaning, and the like. However, in the wild in the application of an animal deterrent pepper spray, the propellant must of necessity be of a higher energy (pressure) level to project the propellant and the liquid a greater typically lateral distance away from the canister at the wild animal than as opposed to for instance a human criminal self defense spray application, for use in a personal self defense manner. Wherein, for comparison the human criminal is typically in close proximity, say approximately 6 feet or so, to the individual using the personal self defense spray as opposed to the animal deterrent spray application wherein the animal may be 30 feet or so away from the user. In fact some United States state laws limit the pepper spray canister volumetric capacity, the oleoresin capsicum concentration, and/or the projection distance for personal self defense pepper spray as against human criminals, thus bringing a legal distinction as between criminal self defense pepper sprays and animal deterrent pepper sprays that are regulated by the United States Environmental Protection Agency (EPA) as a pesticide.

Two of the determinants of the pepper spray projection distance (not including the valve and nozzle) are the propellant, in terms of internal pressure, and the mass weight of the liquid, thus in general high propellant pressure and high mass weight equals a longer spray projection distance and a lower propellant pressure and lower mass weight for the liquid equals a shorter spray projection distance. Thus for a given spray projection distance there is an inverse relationship as between the vapor pressure of the propellant and the mass weight of the liquid, further a lower vapor pressure propellant combined with a higher mass weight fluid will have about the same projection spray distance as a higher vapor pressure propellant combined with a lower mass weight fluid. As the propellant is a highly volatile substance and in the past has utilized chlorofluorocarbons that are causing current environmental concern over the earth's atmospheric ozone layer being harmed in part by the presence of chlorine atoms that were released into the earth's atmosphere by the use of the spray canister, whether it's hair spray, spray paint, or other any similar type item. The atmospheric ozone layer is widely believed to help protect the earth's inhabitants from dangerous Ultra Violet (UV) rays from the sun which can lead to skin cancer in humans, can cause damage to plant life, and can cause harm to plankton populations in the ocean, as a few examples of the potential risks to the earth from UV rays penetrating through the atmosphere. Thus, there is a level of debate of the spray propellant's direct harm to the ozone layer and the resultant probable damage to life on earth, however, developing propellant's without chlorine atoms is widely accepted and encouraged to at least minimize the potential harm to the ozone layer from human activities on the earth's surface.

Thus, there is a need for an environmentally improved propellant as a component to a high energy level spray for animal deterrent sprays that can project over considerably longer distances than personal self defense sprays can or need to project as previously described. One such chemical that is less harmful to the environment as determined by the Environmental Protection Agency (EPA) is Hydrofluorocarbon 152a; being commercially named Dymel 152a. Hydrofluorocarbon 152a is the chemical that propels the repellent spray when used and is less harmful to the environment than other similar propellants are. When threatened or attacked by an animal, the individual user can thwart the animal's attack by spraying the animal's eye and nostril area with the animal deterring spray with a more environmentally friendly propellant component of the animal deterrent spray. Unlike a criminal threat which typically occurs in close proximity to the individual user, such as mugging, stabbing, and fighting, an animal attack typically begins a distance away of about five (5) to fifty (50) feet with the animal charging towards its prey or on this case the individual user. Therefore it is important to deter the dangerous animal at a safe distance before the animal has a chance to harm by contact in close proximity with the individual user.

Looking at the prior art in this area starting with propellants that use the previously discussed Hydrofluorocarbon 152a, in U.S. Pat. No. 6,284,225 to Bhatt et al., disclosed a foaming propellant for use in hair mousse compositions containing Hydrofluorocarbon 152a and a suitable hydrocarbon in a ratio of about 30 to 70; to about 50 to 50; more preferably about 40 to 60, reference column 2, lines 63-67. Also, in U.S. Pat. No. 6,585,965 to Carballada et al., disclosed is a hair care composition comprising polyalkylene glycol styling agents wherein suitable propellants include hydrocarbons, nitrogen, carbon dioxide, nitrous oxide, atmospheric gas, 1,2-difluoroethane (Hydrofluorocarbon 152a) supplied as Dymel 152a by DUPONT, dimethylether, and other mixtures thereof. Preferred in Carballada et al., are the hydrocarbon propellants, specific examples of which include propane, butane, and isobutene, reference column 10, lines 19-25. Both Bhatt et al., and Carballada et al., use Hydrofluorocarbon 152a in propellants; however, they both teach use in human hair care styling products, not for thwarting off an on-coming animal attack.

Moving along with propellants using Hydrofluorocarbon 152a, in U.S. Pat. No. 6,627,585 to Steer disclosed is a human hair mousse-forming cleansing shampoo composition having improved conditioning performance comprising a foamable concentrate with at least one surfactant, dispersed particles of water-insoluble conditioning agent having a particle size of one micron or greater, an aqueous carrier, and an aerosol propellant, reference column 1, lines 64-67 and column 2, lines 1-5. In Steer, the propellant gas can be any liquefiable gaseous composition conventionally used for aerosol containers, such as dimethyl ether, propane, n-butane and isobutane, used singly or admixed. Other examples of propellants in Steer are nitrogen, carbon dioxide, compressed air and hydrofluorocarbons such as the material sold by DUPONT under the trade name Dymel 152a, see column 11, lines 6-11. Steer's invention optionally uses Hydrofluorocarbon 152 as a liquefiable propellant gas in a human hair mousse-forming cleansing shampoo composition, with no teaching for use as against a wild animal.

Furthermore, in U.S. Pat. No. 6,555,117 to Midha et al., disclosed is a human personal hair care composition comprising a silicone grafted adhesive polymer, with the polymer being characterized by an organic polymeric backbone wherein the backbone comprises at least one monomer wherein when the monomer is polymerized as a homopolymer having a Tg of from about −120° C. to about 25° C., and at least one monomer wherein the monomer is polymerized as a homopolymer having a Tg of from above about 25° C. to about 250° C. The silicone grafted adhesive polymer in Midha et al., has silicone macromers grafted to the backbone and wherein the number average molecular weight of the silicone macromers is greater than about 1000. Midha et al.'s composition also comprises a personal care carrier, reference column 2, lines 8-23. Suitable propellants for use in Midha et al., are volatile hydrocarbon propellants which can include liquefied lower hydrocarbons of 3 to 4 carbon atoms such as propane, butane and isobutane. Other suitable propellants in Midha et al., are hydrofluorocarbons such as 1,2-difluoroethane (Hydrofluorocarbon 152a) supplied as Dymel 152a by DUPONT, reference column 13, lines 62-67. Midha et al., also optionally uses Hydrofluorocarbon 152a as a suitable propellant in a personal care composition. As with Bhatt et al., Carballada et al., and Steer, Midha et al.'s invention is not taught as being capable of fending off a threatening animal because it does not include any components used in animal deterrent sprays such as oleoresin capsicum.

Other animal deterrent systems in this area not using Hydrofluorocarbon 152a as a spray propellant include U.S. Pat. No. 6,543,365 to Vasel et al. wherein disclosed is a non-lethal projectile system for inhibiting a living target with either a contained liquid or powder such as oleoresin capsicum; capsaicin; tear gas; a marking or tagging substance, such as colored dye; and/or an inert substance, such as talcum or water; or any combination thereof, wherein these substances are disposed within a projectile that disburses these substances upon impact with the animal or person. The projectile system in Vasel et al., comprises the projectile body, e.g. spherical capsule, separable into two equal halves, wherein the halves contain the powdered impairing substance, reference column 7, lines 62-67, column 8, lines 1-3, and column 9, lines 5-7. Vasel et al., uses a non-lethal projectile system, however, the system comprises a projectile body, i.e. a bullet, as there is no teaching related to the use of a spray propellant.

Continuing in this area in U.S. Pat. No. 7,270,802 to Loghman-Adham which discloses a non-lethal temporarily incapacitating formulation allowing the ready dispersion of active ingredients including oil-based inflammatory agents, such as those in the capsaicin family, to readily dissolve, thus allowing the use of lower concentrations of capsaicins and/or increasing the effectiveness of the spray. The non-lethal formulation of Loghman-Adham's invention results in shorter times being required for the target to become incapacitated as well as a longer duration of incapacitation than possible with known conventional pepper sprays and lachrymator sprays, reference column 3, lines 58-67. The solvent system of Loghman-Adham's invention is environmentally safe and readily biodegradable and testing undertaken has shown that the solvent will undergo rapid and extensive biodegradation in the environment, reference column 6, lines 26-29. Although Loghman-Adham's invention is environmentally safe and formulated to incapacitate an attacker, Loghman-Adham does not teach the distance their propellant is capable of covering, however, the distance is assumed to be short and in close relation or proximity to the attacker as Loghman-Adham's is taught as a self defense type spray, wherein the spray distance is typically about three feet.

Another propellant, in U.S. Pat. No. 6,126,040 to Hippensteel discloses an anti-assault apparatus which includes a canister for containing a pressurized repellent such as mace, pepper spray, or tear gas. The canister in Hippensteel can be discharged in a directed spray to deter attack by a person or animal. The canister in Hippensteel is relatively small, preferably four centimeters or less in its dimension, and thus is readably concealed. Also in Hippensteel, the canister can include a clip for removably attaching the canister to an article worn or carried by a person, a valve is configured to discharge a limited amount of repellent in each activation of the valve to allow the user several opportunities to disable an attacker, reference column 1, lines 55-67. As previously stated, Hippensteel's invention is preferably four centimeters or less in its dimension and may be worn or carried by a person as it would be easy to conceal, however, with such a small volumetric capacity device, the range of the repellant would be limited to a close confrontation or about three feet or so with the attacker after the attacker has engaged with its victim rather than preventing the attacker from attacking.

Along with propellants, an animal deterring device in United States Patent Application Publication Number 2005/0028720 to Bell et al., discloses a device carried by the human hiker that comprises a pop-up figure that is large and may be rapidly deployed by the user. The figure in Bell et al., is meant to scare away an attacking or aggressive animal such as a bear. The activation in Bell et al., of the pop-up figure may be accompanied by noises and/or smells and/or projectiles and/or smoke, reference page 1, paragraph 6. Even though Bell et al.'s invention is designed to work from a safe distance, the device discharges debris that would need to be collected after the attacker has fled. Also, Bell et al., does not address the effect the invention's embodiments, i.e., noxious gas and liquid, smoke, odor, and projectiles, has on the environment. There is no specific teaching in Bell et al., related to a propellant type or the distance that the propellant could drive the noise, projectile, or smoke.

What is needed is an animal deterrent spray that has a propellant that is more environmentally friendly, wherein a portion of the disclosed prior art utilizes the chemical Hydrofluorocarbon 152a, that is taught for use in human hair care products i.e. typically for human hair styling products, i.e. mousse, gel, and hairspray. This chemical propellant is important to human hair styling products so that when applying and styling, the chemicals released will be more environmentally friendly to the atmosphere. However, using human hair care products containing Hydrofluorocarbon 152a to defend against an animal attack at a distance would not prevent the attack, as hair care products do not contain capsicum, capsaicin, and other ingredients that are used in self-defense propellants to deter the attacking animal. Furthermore, the propellant would need to be capable of deterring the attacking animal from a safe distance from about five (5) to fifty (50) feet being much greater than a typical hair care product spray distance of about one (1) to two (2) feet that would be required wherein the prey (person) is out of direct injury reach to the attacking animal.

Thus, there remains a need for an animal deterrent spray including a propellant to be friendly to the environment requiring a propellant including Hydrofluorocarbon 152 which has been approved by the EPA, or an equivalent which has the capability for long distance spray projection to deter an animal as a distance.

### SUMMARY OF INVENTION

Broadly, the present invention is an animal deterrent apparatus for use in an external environment, to help prevent an attack by an animal, the animal deterrent apparatus includes a base, a surrounding sidewall extending from the base, with the surrounding sidewall terminating in an aperture portion, further the base and the surrounding sidewall define an interior. Also included in the animal deterrent apparatus is a valve disposed within the aperture portion, the valve having a manually selected open operational state and a normally closed operational state. Further included in the animal deterrent apparatus is a spray nozzle orifice adjacent to the valve and operational to be in fluid communication with the valve, wherein when the valve is in the open operational state fluid communication is facilitated between the interior and the external environment and when the valve is in the normally closed operational state fluid communication is substantially precluded from the interior to the external environment. In addition, a composition is disposed within the interior, wherein the composition includes a capsicum element, a heavy solvent, an emulsifier, and a light propellant, wherein operationally the composition is selectably manually dispersed by a user from the interior to the external environment being directed a distance in an atomized form at the animal.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a perspective view of the animal deterrent apparatus;

FIG. 2 shows a cross sectional view of the animal deterrent apparatus including the base, surrounding sidewall, aperture portion, interior, valve, and spray nozzle orifice;

FIG. 3 shows an in use perspective view of the animal deterrent apparatus being used by a user as an assistance to deterring the animal; and

FIG. 4 shows an in use perspective view of FIG. 3 with an expanded view of the atomized form of dispersion being directed at the face of the animal.

### REFERENCE NUMBERS IN DRAWINGS

30 Animal deterrent composition
35 Incapacitating solution element of the composition 30
40 Capsicum element of the incapacitating solution 35
45 Emulsifier element of the incapacitating solution 35
50 Heavy solvent of the composition 30
55 Light propellant of the composition 30
60 Animal deterrent apparatus
65 External environment
70 Animal
75 Facial area of the animal 70
80 Base
85 Surrounding sidewall
90 Aperture portion
95 Interior
100 Valve
105 Open operational state of the valve 100
110 Closed operational state of the valve 100
115 Spray nozzle orifice
120 Fluid communication between the interior 95, the valve 100, and spray nozzle orifice 115
125 Manual dispersion of composition 30 by the user 160
130 Distance of dispersion 125
135 Atomized form of dispersion 125
140 Directing the atomized form of dispersion 125
145 Method of deterring an animal 70
150 Providing the composition 30
155 Applying the composition 30
160 User

### DETAILED DESCRIPTION

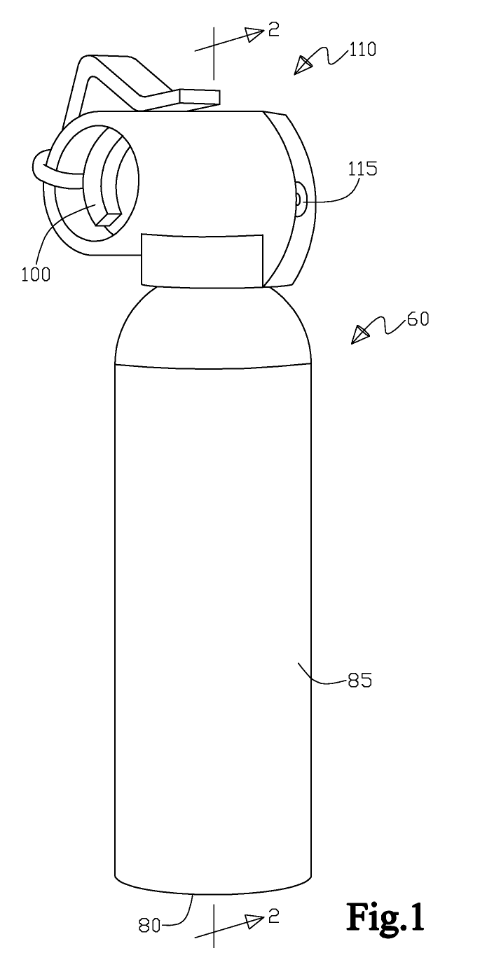

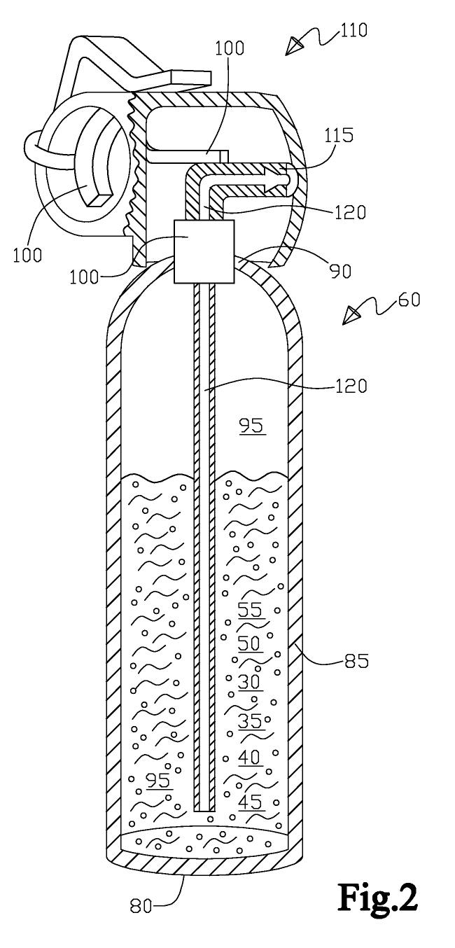

With initial reference to FIG. 1 shown is a perspective view of the animal deterrent apparatus 60 itself that includes the base 80, the surrounding sidewall 85, the valve 100, and the spray nozzle orifice 115, with the valve in the normally closed operational state 110. Moving next to FIG. 2 shown is a cross sectional view 2-2 from FIG. 1 of the animal deterrent apparatus 60 including the base 80, the surrounding sidewall 85, the aperture portion 90, the interior 95 that is formed by the combination of the base 80 and the surrounding sidewall 85, the valve 100 in the closed operational state 110, and the spray nozzle orifice 115, including the animal deterrent composition 30 disposed within the interior 95. Further, FIG. 2 shows the fluid communication 120 from the interior 95 to the valve 100 and continuing to the spray nozzle orifice 115, in addition to the included valve 100 components that allow for the manual user 160 (not shown) selectable moving of the valve 100 from the closed operational state 110 (shown) to the valve 100 open operational state 105 (not shown).

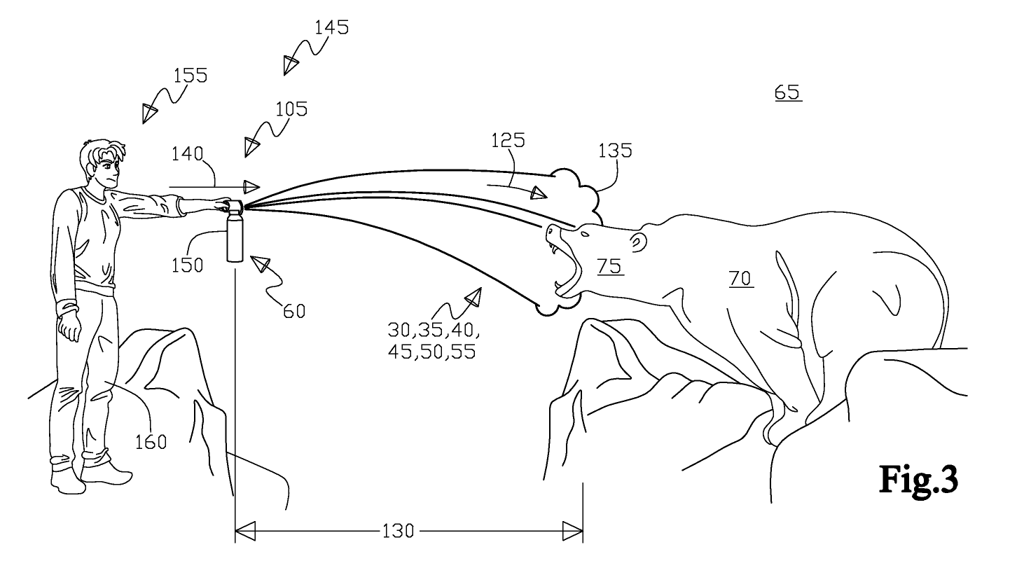

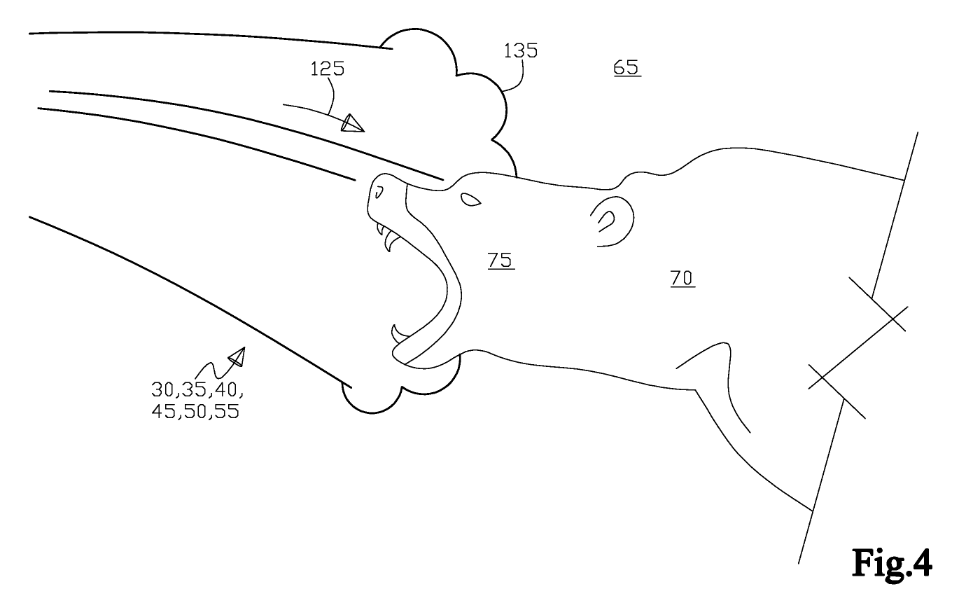

Continuing to FIG. 3 shown is a use perspective view of the animal deterrent apparatus 60 being used by a user 160 as an assistance to deterring the animal 70, wherein the atomized form of dispersion 135 of the provided 150 animal deterrent composition 30 is shown projecting over a distance 130 preferably into the facial area 75 of the animal 70 in the external environment 65. Wherein the atomized form of dispersion 135 of the animal deterrent composition 30 is shown projecting in a selected directed manner 140 over a distance 130 that is manually initiated and dispersed 125 by the user 160 thereby applying 155 the composition 30 to the facial area 75 of the animal 70 to execute the method of 145 deterring the animal 70. Furthermore, FIG. 4 shows an in use perspective view of FIG. 3 with an expanded view of the atomized form of dispersion 135 being directed at the face 75 of the animal 70, wherein the animal deterrent composition 30 includes an element of an incapacitating solution 35 that further preferably includes elements of capsicum 40 and an emulsifier 45 that act to disable the animal 70 by severely irritating the mucous membranes of the animals 70 eyes, nose, and mouth of the animals facial area 75 for a limited amount time.

Broadly the present invention of the animal deterrent composition 30, referencing FIGS. 2 through 4, includes an incapacitating solution 35, a heavy solvent 50, and a light propellant 55, wherein the goal is to utilize a light propellant 55 preferably being an aerosol propellant such as DUPONT DYMEL 152a that has the desired property of not containing any chlorine atoms, and as such falls outside of concerns related to stratospheric ozone destruction by chlorofluorocarbons or other chlorinated hydrocarbons. Thus an aerosol propellant 55 such as DUPONT DYMEL 152a has no ozone depletion potential and the United States Environmental Protection Agency (EPA) has found that this above referenced aerosol propellant is not a Volatile Organic Compound (VOC). However, a characteristic of DUPONT DYMEL 152a in its non atmospheric ozone depleting properties results in a lower molecular weight, (being 66.1) than prior aerosol propellants, however having similar vapor pressure, i.e. at about 63 psig at 70 degrees Fahrenheit, DUPONT DYMEL 152a is close to a typical prior art chlorinated fluorocarbon (CFC)-12 aerosol propellant also known as Dimethyl Ether as far as vapor pressure is concerned. Note, that as previously mentioned the low molecular weight of DUPONT DYMEL 152a results is a lower specific gravity than typical prior art ozone depleting aerosol propellants, wherein DUPONT DYMEL 152a has a specific gravity of about 0.8 wherein a prior art atmospheric ozone depleting aerosol propellant being a chlorinated fluorocarbon for example has a specific gravity of about 1.3.

Thus this is where the term “light propellant” 55 having a specific gravity of about 0.8 comes from as being compared to the prior art “heavy propellant” having a specific gravity of about 1.3, as previously described. Other properties of the preferable aerosol propellant 55 would be a Lower Explosive Limit (LEL) greater than about two point five (2.5) volume percent in atmospheric air, that would further add to the reduced flame extension or flashback potential thus reducing the flammability risk when the composition mixture is sprayed in the atomized mist form projection, as compared to isobutane for example that has an LEL of 1.8, that would typically give a greater flame extension when sprayed through the canister valve and nozzle orifice. Wherein a lower LEL would mean that it takes less of the flammable substance present to be flammable in atmospheric air and thus more dangerous.

With an aerosol product such as a consumer based hair spray, spray mousse, and the like, the atomized mist actual spray projection distance is in the desired range of about one-two feet with the composite aerosol product mixture being disposed upon the user's hair on their head or sometimes in the user's hand before applying it to their hair. The spray projection distance from the spray canister is based upon a number of factors including vapor pressure of the propellant, temperature, components—or more technically the composite weight of the spray can contents mixture that makes up the hair spray; for instance solvents, lacquers, fragrances, surfactants or emulsifiers, resins, and the like, in addition to the fluid communication elements such as spray canister valving and discharge nozzle orifices. Wherein, typically a higher vapor pressure aerosol propellant and a higher specific gravity of the mixture result in a longer atomized mixture spray projection distance and vice versa i.e. a lower vapor pressure of the aerosol propellant and a light specific gravity of the spray can mixture result in a shorter atomized mixture spray projection distance. The result in using the relatively light specific gravity DUPONT DYMEL 152a aerosol propellant for a consumer product hair spray canister has a minor effect on the applicability of using the consumer aerosol hair product as the canister contents mixture atomized spray projection distance needed is not that great or even critical being in the previously mentioned atomized spray projection range of one-two feet.

With DUPONT DYMEL 152a being primarily developed for general consumer applications such as hair spray or mousses sprayed from a canister, the effect of the lighter specific gravity of DUPONT DYMEL 152a as compared to the prior art aerosol propellants such as the chlorinated fluorocarbons for example having typically higher specific gravity has not been a significant issue. However, in the case of the present invention being an animal deterrent spray composition 30, the atomized canister mixture spray projection distance is an issue as this spray projection distance 130, see FIG. 3, is considerably longer at ten to thirty or more feet as compared to the previously mentioned consumer based hair care aerosol product only needing typically one-two feet of atomized canister spray projection distance. Thus, the aforementioned factors of what affects the atomized spray projection distance 130 are important in the present invention, plus with the desire to move toward a more environmentally friendly non atmospheric ozone depleting aerosol propellant such as DUPONT DYMEL 152a that has a lighter specific gravity than what was previously used requires adjustment in at least one of the previously mentioned factors affecting atomized spray projection distance, whether it's valving, nozzle/orifice design or in the mixture disposed within the canister to bring the composite specific gravity upward to regain the specific gravity lost through the use of DUPONT DYMEL 152a as the aerosol propellant.

Thus, this is where the “heavy solvent” 50 term comes from wherein the solvent specific gravity can be increased to make-up for the reduction in specific gravity due to the DUPONT DYMEL 152a as the aerosol propellant 55, thus resulting in the canister mixture having a substantially matching overall specific gravity to what existed before using the prior art heavier (higher specific gravity) atmospheric ozone depleting aerosol propellant being a chlorinated fluorocarbon and a lighter solvent. In other words, the goal being to substantially match the atomized canister spray projection distance 130, as best shown in FIG. 3, when using the prior art heavier atmospheric ozone depleting aerosol propellant versus using the non atmospheric ozone depleting lighter (lower specific gravity) DUPONT DYMEL 152a as the aerosol propellant 55. Note that it would be acceptable for the present invention to use a substantial equivalent aerosol propellant 55 to DUPONT DYMEL 152a as previously described.

As to the termed “heavy solvent” 50 it is preferably a brand OXSOL 100 solvent from OXYCHEM that has a higher specific gravity of about 1.3 in order to compensate for the DUPONT DYMEL 152a as the aerosol propellant 55 having a lower specific gravity as previously described. Thus, there is an inverse relationship between the propellant 55 and the solvent 50 in substantially maintaining the overall specific gravity of the composition mixture to also substantially maintain the atomized canister spray projection distance 130, as shown in FIG. 3.

In other words, previously using a heavier aerosol propellant that had known atmospheric ozone depletion potential such as chlorinated fluorocarbon (CFC)-12 aerosol propellant also known as Dimethyl Ether with a specific gravity of about 1.3 used in conjunction with a solvent having a specific gravity of about 0.8 for the canister composition mixture equates to using an inverse composition mixture of the non atmospheric ozone depleting lighter (lower specific gravity of about 0.8) DUPONT DYMEL 152a as the aerosol propellant 55 in conjunction with a heavier solvent brand OXSOL 100 heavy solvent 50 from OXYCHEM that has a higher specific gravity of about 1.3, results in a similar composition mixture for overall specific gravity as compared to the prior use of utilizing the atmospheric ozone depleting propellant with the maintaining of the desired longer atomization projection distance 130 from FIG. 3. Thus, to keep the utility of the animal deterrent composition 30 with the added benefit of using a non atmospheric ozone depleting aerosol propellant in the composition 30 mixture. Equivalents to the “heavy solvent” 50 brand OXSOL 100 solvent would be acceptable to use also. The specific gravity ranges for the aerosol propellant 55 could vary up to about 1.1 and specific gravity ranges for the solvent 50 could be greater than 1.0. Further, the solvent 50 would preferably be a non Volatile Organic Compound (VOC) type, again for better environmental health thus minimizing the potential atmospheric organic compounds that cause photochemical reactions that can alter natural atmospheric/sunlight interactions.

In looking at the incapacitating solution 35, it is preferably a mixture that includes a capsicum element 40 and an emulsifier element 45, wherein the capsicum element 40 can be made from finely ground peppers and optionally additional like elements, wherein an organic solvent, such as ethanol is used to extract the capsicum from the finely ground peppers or an equivalent substance and when the solvent is evaporated, vegetable oil can be added having the result of a wax like resin being formed that is termed oleoresin capsicum. Further, the emulsifier element 45 can be propylene glycol or an equivalent to suspend the oleoresin capsicum in a liquid with the heavy solvent 50, wherein this liquid is disposed within the canister and the light propellant 55 is added to pressurize the mixture for dispersion energy out of the valve 100 and nozzle 115 as previously described for controlled diffusion 140 and atomization 135 of the pepper type spray. Note, that other types on incapacitating solutions 35 could be used that have equivalent effects of the aforementioned capsicum element 40 and an emulsifier element 45 mixture.

As an option to the composition 30, an animal deterrent apparatus 60, as shown in FIGS. 1 and 2 in particular and in use in FIGS. 3 and 4, that is for use in an external environment 65, to help prevent an attack by an animal 70, wherein the animal deterrent apparatus 60 includes a base 80, a surrounding sidewall 85 extending from the base 80, with the surrounding sidewall 85 terminating in an aperture portion 90, with the base 80 and the surrounding sidewall 85 defining an interior 95 as best shown in FIG. 2. Note that for the materials of construction for the base 80 and the surrounding sidewall 85 that preferably a metallic, aluminum, or composite could be used of adequate strength for the previously mentioned propellant vapor pressure and size of the canister, which for an animal deterrent apparatus 60 would be a typically larger volumetric size, i.e. about 12-15 fluid ounces or so as compared to a personal self defense spray that contains about 1 fluid ounce of fluid, or any other materials that would be suitable for the pressure, external environment 65, and the composition 30, also the base and surrounding sidewall 85 could be integral or multiple piece construction. Further included in the animal deterrent apparatus 60 is a valve 100 disposed within the aperture portion 90, with the valve 100 having a user 160 manually selected open operational state 105, see FIGS. 3 and 4, plus a normally closed operational state 110, see FIGS. 1 and 2. The construction of the valve 100 is of normal materials and components for aerosol canister use.

Continuing on the animal deterrent apparatus 60 a spray nozzle orifice 115 positioned adjacent to the valve 100 and operational to be in fluid communication 120 with the valve 100 and interior 95, as is best shown in FIG. 2, wherein when the valve 100 is in the open operational state 105, see FIGS. 3 and 4, fluid communication 120 is facilitated between the interior 95 and the external environment 65 and when the valve 100 is in the closed operational state 110, see FIGS. 1 and 2, fluid communication 120 is substantially precluded from the interior 95 to the external environment 65. The construction of the spray nozzle orifice 115 is of normal materials and components for aerosol canister use, note that there can be an optional user 160 safety lockable element associated with the valve 100, that can lock the valve 100 in the closed operational state 110 for safety, thus requiring at least two independent motions by the user 160 to selectively place the valve 100 into the open operational state 105, much like the fire extinguisher arts.

Also included in the animal deterrent apparatus 60 is the composition 30 as previously described, and with the substantially consistent composition 30 mixture specific gravity in going from an atmospheric ozone depleting propellant to a non atmospheric ozone depleting propellant also as previously described, the combination of the composition 30 and the animal deterrent apparatus 60 are configured to be capable of being directed in an atomized form 135 to the distance 130 being at least about twenty five (25) feet, as best shown in FIG. 3.

### Method of Use

A method 145 is disclosed of deterring an animal 70, that is preferably a bear, however, any other animal 70 could apply to the aforementioned composition 30, animal deterrent apparatus 60, or this method 145, see FIGS. 3 and 4, the method 145 includes the steps of, firstly providing 150 a composition 30 that includes a capsicum element 40, a heavy solvent 50, an emulsifier 45, and a light propellant 55 for use in an aerosol or spray application as previously described. A further step is in applying 155 the composition 30 that is directed into a facial area 75 of the animal 70, as in the case of FIGS. 3 and 4, a bear. Alternatively, for the method 145 of deterring an animal 70 the composition 30 could include the light propellant 55 having a specific gravity value of less than about one point one (1.1) and the heavy solvent 50 having a specific gravity value greater than about one point zero (1.0).

Further, alternatively on the method 145 of deterring an animal 70 the step of applying 155 the composition 30 includes directing 140 an atomized 135 mist of the composition 30 for a distance 130 of at least about twenty five (25) feet, as best shown in FIG. 3.

### CONCLUSION

Accordingly, the present invention of an animal deterrent composition and apparatus has been described with some degree of particularity directed to the embodiments of the present invention. It should be appreciated, though, that the present invention is defined by the following claims construed in light of the prior art so modifications the changes may be made to the exemplary embodiments of the present invention without departing from the inventive concepts contained therein.

1. An animal deterrent composition, comprising:
(a) an incapacitating solution;
(b) a heavy solvent; and
(c) a light propellant

2. An animal deterrent composition according to claim 1 wherein said incapacitating solution is a capsicum element and an emulsifier.

3. An animal deterrent composition according to claim 1 wherein said heavy solvent is a non Volatile Organic Compound (VOC) type.

4. An animal deterrent composition according to claim 1 wherein said heavy solvent has a specific gravity value greater than about one point zero (1.0)

5. An animal deterrent composition according to claim 1 wherein said light propellant has a specific gravity value of less than about one point one (1.1).

6. An animal deterrent composition according to claim 1 wherein said light propellant is configured to have no atmospheric ozone depletion.

7. An animal deterrent composition according to claim 1 wherein said light propellant has a Lower Explosive Limit (LEL) greater than about two point five (2.5) volume percent in atmospheric air.

8. An animal deterrent apparatus for use in an external environment, to help prevent an attack by an animal, said animal deterrent apparatus comprising:
(a) a base
(b) a surrounding sidewall extending from said base, said surrounding sidewall terminating in an aperture portion, said base and said surrounding sidewall defining an interior;
(c) a valve disposed within said aperture portion, said valve having a manually selected open operational state and a normally closed operational state;
(d) a spray nozzle orifice adjacent to said valve and operational to be in fluid communication with said valve, wherein when said valve is in said manually selected open operational state, fluid communication is facilitated between said interior and the external environment and when said valve is in said normally closed operational state, fluid communication is substantially precluded from said interior to the external environment; and
(e) a composition disposed within said interior, wherein said composition includes a capsicum element, a heavy solvent, an emulsifier, and a light propellant, wherein operationally said composition is selectably manually dispersed from said interior to the external environment being directed a distance in an atomized form at the animal.

9. An animal deterrent apparatus according to claim 8 wherein said light propellant has a specific gravity value of less than about one point one (1.1).

10. An animal deterrent apparatus according to claim 9 wherein said heavy solvent has a specific gravity value greater than about one point zero (1.0).

11. An animal deterrent apparatus according to claim 8 wherein said light propellant is configured to have no atmospheric ozone depletion.

12. An animal deterrent apparatus according to claim 8 wherein said light propellant has a Lower Explosive Limit (LEL) greater than about two point five (2.5) volume percent in atmospheric air.

13. An animal deterrent apparatus according to claim 10 wherein said composition is configured to be capable of being directed in said atomized form to said distance being at least twenty five (25) feet.

14. A method of deterring an animal, comprising the steps of:
(a) providing a composition that includes a capsicum element, a heavy solvent, an emulsifier, and a light propellant for use in an aerosol or spray application; and
(b) applying said composition that is directed into a facial area of the animal.

15. A method of deterring an animal according to claim 14 wherein said step of providing said composition includes said light propellant having a specific gravity value of less than about one point one (1.1) and said heavy solvent having a specific gravity value greater than about one point zero (1.0).

16. A method of deterring an animal according to claim 15 wherein said step of applying said composition includes directing an atomized form of said composition for a distance of at least twenty five (25) feet.
